(19) United States
(12) Patent Application Publication
(10) Pub. No.: US 2024/0048716 A1
(43) Pub. Date: Feb. 8, 2024

(54) IMAGE PROCESSING METHOD AND DEVICE, STORAGE MEDIUM AND ELECTRONIC DEVICE

(71) Applicant: LYNXI TECHNOLOGIES CO., LTD., Beijing (CN)

(72) Inventors: Zhenzhi WU, Beijing (CN); Jian LI, Beijing (CN); Zheyu YANG, Beijing (CN); Yaolong ZHU, Beijing (CN)

(21) Appl. No.: 18/265,710

(22) PCT Filed: Jun. 10, 2022
(86) PCT No.: PCT/CN2022/098196

§ 371 Date: Jun. 7, 2023

(30) Foreign Application Priority Data
Jun. 18, 2021 (CN) 202110678724.1

(51) Int. Cl. H04N 19/136; H04N 19/172; G06V 10/40; G06V 40/10

(52) U.S. Cl. CPC H04N 19/136; H04N 19/172; G06V 10/40; G06V 40/10

(57) ABSTRACT

The present disclosure relates to an image processing method and device, a storage medium and an electronic device. The image processing method includes: acquiring a current frame image, and performing semantic feature extraction processing on the current frame image to obtain a semantic feature set of the current frame image; determining a historical frame image matched with the current frame image, and acquiring frame number information of the historical frame image; and generating a compressed information packet according to the semantic feature set of the current frame image and the frame number information of the historical frame image, and storing and/or transmitting the compressed information packet. Thus, the image processing method can increase an image compression ratio while ensuring image quality, thereby allowing image information to be transmitted and stored conveniently.

### TECHNICAL FIELD

The present disclosure relates to the technical field of data processing, and in particular, to an image processing method, a computer-readable storage medium, an electronic device, and an image processing device.

### BACKGROUND

At present, technologies such as image classification and image retrieval in the field of computer vision are developing rapidly, and real images have relatively large magnitude, thereby requiring large storage space. Moreover, digital image communication with huge data volume brings a great challenge to the existing limited bandwidths, so that the image compression technology attracts more and more attention. In the related art, the technical solutions of image compression generally focus on how to retain details of images but cannot realize a large compression ratio, resulting in poor quality of compressed images and an adverse effect on user experience.

### SUMMARY

Embodiments of the present disclosure provide an image processing method and device, a storage medium and an electronic device, which can increase an image compression ratio while ensuring image quality, so as to facilitate transmission and storage of images.

The first objective of the present disclosure is to provide an image processing method.

The second objective of the present disclosure is to provide another image processing method.

The third objective of the present disclosure is to provide a computer-readable storage medium.

The fourth objective of the present disclosure is to provide an electronic device.

The fifth objective of the present disclosure is to provide an image processing device.

In order to achieve the above objectives, the first aspect of the embodiments of the present disclosure provides an image processing method, including: acquiring a current frame image, and performing semantic feature extraction processing on the current frame image to obtain a semantic feature set of the current frame image; determining a historical frame image matched with the current frame image, and acquiring frame number information of the historical frame image; and generating a compressed information packet according to the semantic feature set of the current frame image and the frame number information of the historical frame image, and storing and/or transmitting the compressed information packet.

According to the image processing method provided by the embodiments of the present disclosure, the current frame image is first acquired, the semantic feature extraction processing is then performed on the current frame image to obtain the semantic feature set of the current frame image, the historical frame image matched with the current frame image is determined, the frame number information of the historical frame image is acquired, and then the compressed information packet is generated according to the semantic feature set of the current frame image and the frame number information of the historical frame image and is stored and/or transmitted. Thus, the image processing method can increase the image compression ratio while ensuring the image quality, thereby allowing image information to be transmitted and stored conveniently.

In addition, the image processing method according to the above embodiments of the present disclosure may further have the following additional technical features.

According to an embodiment of the present disclosure, after storing the compressed information packet, the image processing method further includes: acquiring the semantic feature set of the current frame image and the frame number information of the historical frame image from the compressed information packet; and acquiring the historical frame image from a historical frame library according to the frame number information of the historical frame image, and performing image reconstruction according to the historical frame image and the semantic feature set of the current frame image to obtain a decompressed image corresponding to the current frame image.

According to an embodiment of the present disclosure, one frame of image is selected and stored in the historical frame library at preset intervals, so as to update the historical frame library.

According to an embodiment of the present disclosure, a frame of image whose image change satisfies a preset requirement is taken as the historical frame image.

According to an embodiment of the present disclosure, in a case where the current frame image is an image containing a person, performing the semantic feature extraction processing on the current frame image includes: detecting person in the current frame image, and acquiring Identity Document (ID) information of at least one person; recognizing a person-related attribute of the current frame image to obtain feature information of the at least one person; and encoding the feature information of the at least one person, and generating the semantic feature set of the current frame image according to an encoding result and the ID information of the at least one person.

According to an embodiment of the present disclosure, the feature information of the at least one person includes at least one of skeleton and outline information, pose information, head angle information, hair style information, and expression information of the at least one person.

According to an embodiment of the present disclosure, performing the image reconstruction according to the historical frame image and the semantic feature set of the current frame image includes: determining the feature information of the at least one person according to the ID information of the at least one person, and generating, according to the feature information of the at least one person, an image of the at least one person by adopting a human image generation network; and generating the decompressed image by adopting a full-image generation network according to the outline information of the at least one person, the image of the at least one person and the historical frame image.

In order to achieve the above objectives, the second aspect of the embodiments of the present disclosure provides another image processing method, including: receiving a compressed information packet, wherein the compressed information packet is generated according to a semantic feature set of a current frame image and frame number information of a historical frame image, the semantic feature set of the current frame image is obtained by performing semantic feature extraction processing on the current frame image, and the frame number information is the frame number information of the historical frame image matched with the current frame image; acquiring the semantic feature set of the current frame image and the frame number information of the historical frame image from the compressed information packet; and acquiring the historical frame image from a historical frame library according to the frame number information of the historical frame image, and performing the image reconstruction according to the historical frame image and the semantic feature set of the current frame image to obtain the decompressed image corresponding to the current frame image.

According to the image processing method provided by the embodiments of the present disclosure, the compressed information packet is first received, the compressed information packet is generated according to the semantic feature set of the current frame image and the frame number information of the historical frame image, the semantic feature set of the current frame image is acquired by performing the semantic feature extraction processing on the current frame image, the frame number information is the frame number information of the historical frame image matched with the current frame image, the semantic feature set of the current frame image and the frame number information of the historical frame image are acquired from the compressed information packet, then the historical frame image is acquired from the historical frame library according to the frame number information of the historical frame image, and the image reconstruction is performed according to the historical frame image and the semantic feature set of the current frame image to obtain the decompressed image corresponding to the current frame imaged. Thus, the image processing method can perform image decompression processing while ensuring the image quality, so as to avoid quality deterioration of the decompressed image.

In order to achieve the above objectives, the third aspect of the embodiments of the present disclosure provides a computer-readable storage medium having stored thereon an image processing program, which, when executed by a processor, causes the processor to perform the image processing methods described in the above embodiments.

Through the image processing program stored on the computer-readable storage medium, the computer-readable storage medium provided by the embodiments of the present disclosure can increase the image compression ratio while ensuring the image quality, thereby allowing image information to be transmitted and stored conveniently.

In order to achieve the above objectives, the fourth aspect of the embodiments of the present disclosure provide an electronic device, including a memory, a processor, and an image processing program which is stored on the memory and capable of running on the processor. When the processor executes the image processing program, the image processing methods described in the above embodiments are performed.

The electronic device provided by the embodiments of the present disclosure includes the memory and the processor. By using the processor to execute the image processing program stored on the memory, the electronic device can increase the image compression ratio while ensuring the image quality, thereby allowing the image information to be transmitted and stored conveniently.

In order to achieve the above objectives, the fifth aspect of the embodiments of the present disclosure provides an image processing device, including an acquisition module configured to acquire a current frame image; a semantic extraction module configured to process the current frame image with a semantic extractor to obtain a semantic feature set of the current frame image; a determination module configured to determine a historical frame image matched with the current frame image and acquire frame number information of the historical frame image; and a compression module configured to generate a compressed information packet according to the semantic feature set of the current frame image and the frame number information of the historical frame image, and store and/or transmit the compressed information packet.

The image processing device provided by the embodiments of the present disclosure includes the acquisition module, the semantic extraction module, the determination module and the compression module. The acquisition module is used to acquire the current frame image first, the semantic extraction module is then used to perform semantic feature extraction processing on the current frame image acquired by the acquisition module to obtain the semantic feature set of the current frame image, the determination module is then used to determine the historical frame image matched with the current frame image and acquire the frame number information of the historical frame image, and the compression module is finally used to generate the compression information packet according to the semantic feature set of the current frame image and the frame number information of the historical frame image and store and/or transmit the compression information packet. Thus, the image processing device can increase the image compression ratio while ensuring the image quality, thereby allowing the image information to be transmitted and stored conveniently.

Additional aspects and advantages of the present disclosure will be partially described in the following description, and will become partially apparent from the following description or will be understood through the implementation of the present disclosure.

It should be understood that both the above general description and the following detailed description are just for illustration and explanation, but are not intended to limit the present disclosure. Other features and aspects of the present disclosure will become apparent from the following detailed description of exemplary embodiments with reference to the accompanying drawings.

### BRIEF DESCRIPTION OF DRAWINGS

FIG. 1 is a flowchart illustrating an image processing method according to the present disclosure;

FIG. 2 is a flowchart illustrating another image processing method according to the present disclosure;

FIG. 3 is a flowchart illustrating still another image processing method according to the present disclosure;

FIG. 4 is a schematic diagram of a semantic feature set according to the present disclosure;

FIG. 5 is a schematic diagram illustrating generation of a compressed information packet according to the present disclosure;

FIG. 6 is a flowchart illustrating image reconstruction according to the present disclosure;

FIG. 7 is a schematic flowchart illustrating image reconstruction according to the present disclosure;

FIG. 8 is a flowchart illustrating yet another image processing method according to the present disclosure;

FIG. 9 is a block diagram of an electronic device according to the present disclosure; and

FIG. 10 is a block diagram of an image processing device according to the present disclosure.

### DETAIL DESCRIPTION OF EMBODIMENTS

The present disclosure is further described in detail below with reference to the drawings and the embodiments. It should be understood that the specific embodiments described herein are just for explaining the present disclosure, rather than limiting the present disclosure. It should be further noted that only some, rather than all, of the structures related to the present disclosure are illustrated in the drawings for convenience of description.

The image processing method and device, the computer-readable storage medium, and the electronic device provided by the embodiments of the present disclosure are described below with reference to the drawings.

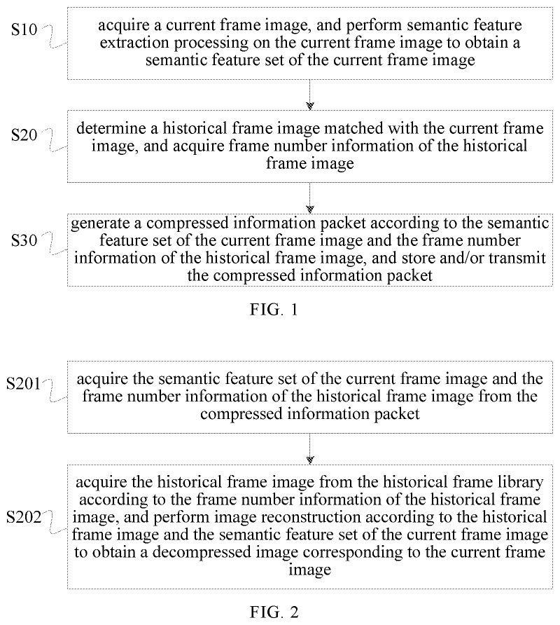

FIG. 1 is a flowchart illustrating an image processing method according to the present disclosure.

As shown in FIG. 1, the image processing method according to the present disclosure includes the following operations S10 to S30.

In S10, a current frame image is acquired, and semantic feature extraction processing is performed on the current frame image to obtain a semantic feature set of the current frame image.

The current frame image is an image which needs to be currently subjected to image compression. The current frame image may be a picture which exists alone, or any one frame of image that is captured from a video.

Semantic features of an image are divided into visual layer features, object layer features and concept layer features. A visual layer is the commonly understood bottom layer, the visual layer features include color, texture, shape, etc., and those features are all called bottom semantic features; an object layer is a middle layer, and the object layer features generally include attribute features, that is, a state of a certain object at a certain moment; and a concept layer is a high layer and is what is represented by the image and is closest to human understanding. For example, for a picture showing sand, blue sky, seawater, etc., the visual layer is blocks that are divided, the object layer is the sand, the blue sky and the seawater, and the concept layer is a beach.

In the embodiment of the present disclosure, the operation of performing the semantic feature extraction processing on the current frame image to obtain the semantic feature set of the current frame image is for facilitating performing image compression on the current frame image in subsequent processes. It should be noted that a purpose of the image compression is to represent an original larger image by as few bytes as possible for storage or transmission, and to allow restoration based on a compressed information packet obtained by the compression to obtain a restored image with good quality. By adopting the image compression, a burden of the storage or transmission of the image can be reduced, so that the image can be transmitted rapidly and processed in real time on a network.

In some embodiments, after the current frame image is acquired, a semantic extractor may be used to perform the semantic feature extraction processing on the current frame image. Optionally, a method for processing the current frame image by the semantic extractor may include converting the image into a text description, for example, the method is performed by using Image Captioning neural network; or the method may include allocating a corresponding label and a corresponding feature value, such as color or texture, to a detected object. After the current frame image is processed, the semantic feature set of the current frame image may be obtained.

In S20, a historical frame image matched with the current frame image is determined, and frame number information of the historical frame image is acquired.

The historical frame image may be a pre-recorded snapshot. The historical frame image matched with the current frame image refers to a snapshot corresponding to the current frame image.

In the embodiment of the present disclosure, a historical frame library is further provided and includes historical frame images used for matching with the current frame image. It should be understood that the historical frame images stored in the historical frame library are composed of different images, such as images of different frames in a video.

In some embodiments of the present disclosure, one frame of image may be selected and stored in the historical frame library at preset intervals, so as to update the historical frame library. For example, one frame of image may be selected and stored in the historical frame library every second. Apparently, the selection and storage of the frames of images may also be performed in a segmented manner, for example, one frame of image is selected and stored in the historical frame library every first preset time in a first preset period, and one frame of image is selected and stored in the historical frame library every second preset time in a second preset period.

In some embodiments of the present disclosure, a frame of image whose image change satisfies a preset requirement is taken as the historical frame image. By taking the image whose image change satisfies the preset requirement as the historical frame image, comprehensiveness of the images stored in the historical frame library can be ensured, so that it can be further ensured that the corresponding historical frame image matched with the current frame image is found in the historical frame library, which further ensures quality of the image compression. The preset requirement may be a requirement for pixels of the image, for example, when the pixels of the image which change exceed a preset value, it may be determined that the image change satisfies the preset requirement, and the preset value may be determined according to experiences, or may be adaptively modified according to different accuracy requirements.

In the embodiment, each of the historical frame images in the historical frame library is provided with corresponding frame number information, so that the corresponding historical frame image may be extracted by invoking the corresponding frame number information, which may avoid making mistakes. It should be understood that, in the embodiment, a plurality of historical frame libraries are provided, and a corresponding historical frame library may be determined according to the current frame image before the matching with the corresponding historical frame image is performed, and then the matching is performed by searching the determined historical frame library. Thus, it is not necessary to perform the matching in each of the historical frame libraries, thereby saving matching time.

In S30, a compressed information packet is generated according to the semantic feature set of the current frame image and the frame number information of the historical frame image and is stored and/or transmitted.

For example, after the semantic feature set of the current frame image and the frame number information of the historical frame image matched with the current frame image are acquired, the compressed information packet may be generated according to the acquired information, for example, the semantic feature set of the current frame image and the frame number information of the historical frame image matched with the current frame image are encoded to obtain the compressed information packet, and then the compressed information packet is stored and/or transmitted.

According to the image processing method provided by the embodiments of the present disclosure, the current frame image is first acquired, the semantic feature extraction processing is then performed on the current frame image to obtain the semantic feature set of the current frame image, the historical frame image matched with the current frame image is then determined, the frame number information of the historical frame image is acquired, and then the compressed information packet is generated according to the semantic feature set of the current frame image and the frame number information of the historical frame image and is stored and/or transmitted. Thus, the image processing method can increase an image compression ratio while ensuring image quality, so as to allow image information to be transmitted and stored conveniently.

FIG. 2 is a flowchart illustrating another image processing method according to the present disclosure. In some embodiments of the present disclosure, as shown in FIG. 2, after the compressed information packet is stored, the image processing method further includes the following operations S201 to S202.

In S201, the semantic feature set of the current frame image and the frame number information of the historical frame image are acquired from the compressed information packet.

After the compressed information packet is stored, a decompression side may restore an image semantically similar to the original image based on the information in the compressed information packet when decompressing the compressed information packet and take the restored image as the current frame image. Firstly, the compressed information packet may be decoded to acquire the semantic feature set of the current frame image and the frame number information of the historical frame image.

In S202, the historical frame image is acquired from the historical frame library according to the frame number information of the historical frame image, and image reconstruction is performed according to the historical frame image and the semantic feature set of the current frame image to obtain a decompressed image corresponding to the current frame image.

In the embodiments of the present disclosure, when the current frame image is acquired according to the compressed information packet, the historical frame image may be first acquired from the historical frame library according to the frame number information of the historical frame image, and the image reconstruction may be performed according to the historical frame image and the semantic feature set of the current frame image. In some embodiments, the historical frame image may be found by searching the historical frame library based on the number of a similar frame (the frame number information), and then the image reconstruction is performed based on the semantic feature set of the current frame image to obtain the current frame image. Thus, the decompressed image corresponding to the current frame image is obtained through the reconstruction according to the compressed information packet and the historical frame image.

According to the image processing method provided by the embodiments of the present disclosure, after the compressed information packet is stored, the semantic feature set of the current frame image and the frame number information of the historical frame image are acquired from the compressed information packet, the historical frame image is then acquired from the historical frame library according to the frame number information of the historical frame image, and the image reconstruction is performed according to the semantic feature set of the historical frame image and the current frame image to obtain the decompressed image corresponding to the current frame image. Thus, the image processing method can perform image decompression processing while ensuring the image quality, so as to avoid quality deterioration of the decompressed image.

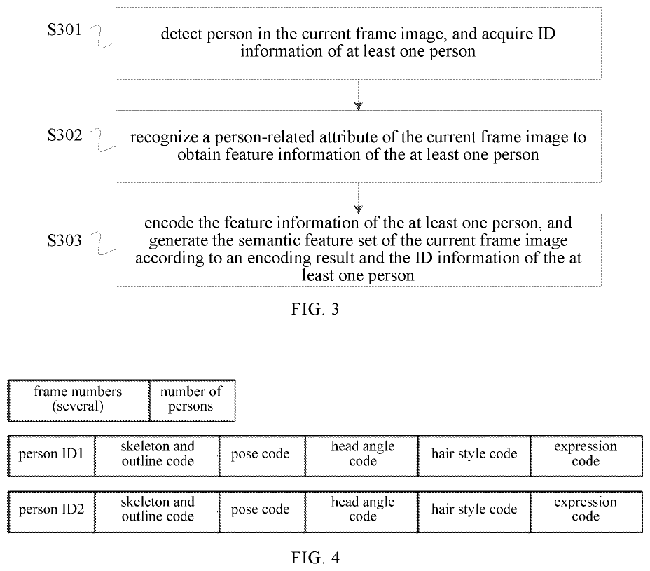

FIG. 3 is a flowchart illustrating still another image processing method according to the present disclosure. In an alternative embodiment of the present disclosure, as shown in FIG. 3, when the current frame image is an image containing a person, performing the semantic feature extraction processing on the current frame image may include the following operations S301 to S303.

In S301, person in the current frame image is detected, and Identity Document (ID) information of at least one person is acquired.

The at least one person includes each or some of persons in the current frame image. In the process of detecting person in the current frame image, acquiring the ID information of some persons may accelerate detection progress and increase image processing efficiency. However, in the process of detecting person in the current frame image, compared with acquiring the ID information of some persons, acquiring the ID information of each person may improve the image quality of the current frame image after being subjected to the image compression. It should be noted that a suitable image processing way may be selected according to a corresponding situation in practical application scenarios, which is not specifically limited in the embodiment.

The image processing method provided by the embodiment may be applied to a video conference scenario. For example, when an image which needs to be compressed or sensed contains N participants facing cameras directly or at a slant, the persons in the current frame image may be first detected to acquire the ID information of each person. It should be understood that recognition of the ID information of the persons may be performed by means of face recognition or full-body recognition, but other recognition ways such as iris recognition may also be adopted, and the recognition ways of the ID information are not limited in the embodiment.

In S302, a person-related attribute of the current frame image is recognized to obtain feature information of the at least one person.

In the embodiment of the present disclosure, the person-related attribute of the current frame image may be further recognized, and the feature information of the at least one person may be obtained by recognizing the person-related attribute. The person-related attribute may be understood as an attribute related to any feature of a person, such as a human head, a human dress, a human expression, or a human accessory.

In some embodiments, the feature information of the person may include at least one of skeleton and outline information, pose information, head angle information, hair style information and expression information of the person. After the feature information of the person is acquired, the acquired information may be encoded to form a text or a binary sequence, so as to reduce an occupied storage space and energy consumption. For example, if a current person has four poses, each of the poses may be represented by one of the binary sequences (00, 01,10, 11), and each binary sequence only takes 2-bit space.

In S303, the feature information of the at least one person is encoded, and the semantic feature set of the current frame image is generated according to an encoding result and the ID information of the at least one person.

In the embodiments of the present disclosure, after the feature information of the at least one person is acquired, the feature information of each of the at least one person may be encoded, for example, the head angle information of the person may be denoted by an integer, the outline information and the skeleton information may be encoded to be denoted by an integer pair (x, y), and the other information may have respective corresponding encoded information, which will not be described in detail here. After the feature information is encoded, the semantic feature set of the current frame image may be generated according to the encoding result of the feature information and the ID information of the corresponding person.

According to the image processing method provided by the embodiments of the present disclosure, when the current frame image is the image containing a person, person in the current frame image is detected, the ID information of at least one person is acquired, the person-related attribute of the current frame image is then recognized to obtain the feature information of the at least one person, the feature information of the at least one person is encoded, and finally the semantic feature set of the current frame image is generated according to the encoding result and the ID information of the at least one person. Thus, the semantic feature extraction processing can be performed in the scenario involving the image containing a person, which facilitates performing the image compression on the image containing a person in subsequence processes, thereby allowing the image information to be transmitted and stored conveniently.

FIG. 4 is a schematic diagram of a semantic feature set according to the present disclosure. As shown in FIG. 4, the semantic feature set may be obtained by combining a person ID, a skeleton and outline code, a pose code, a head angle code, a hair style code and an expression code.

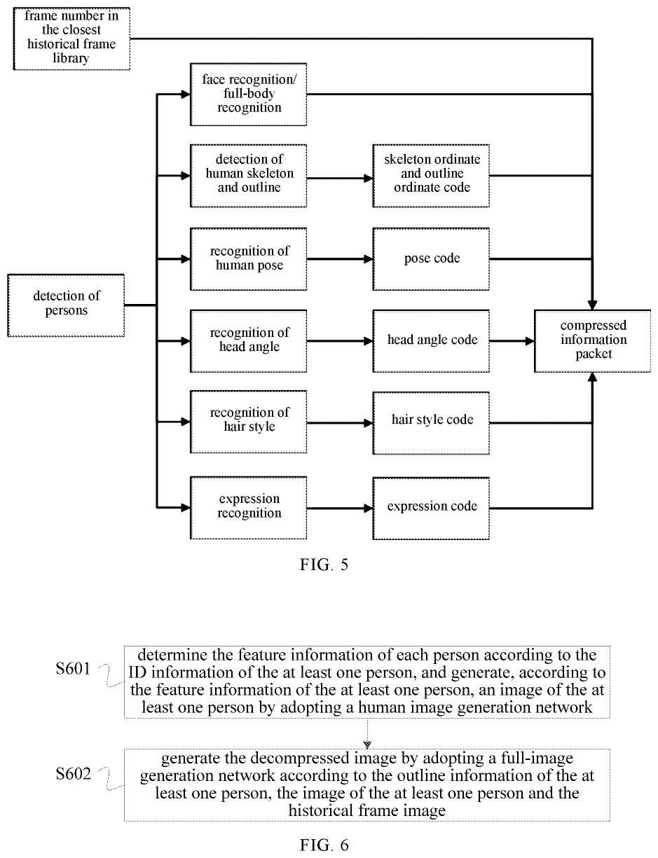

FIG. 5 is a schematic diagram illustrating generation of a compressed information packet according to the present disclosure. It should be noted that, as shown in FIG. 5, after the semantic feature set is determined, the compressed information packet may be generated based on the semantic feature set and the frame number in the closest historical frame library, and the information packet includes full frame information of the current frame image (such as the frame number information of a frame image which is most similar to the current frame in the historical frame library, and the information about the total number of the detected persons in the image) and the encoding information of each person, and it should be noted that the information packet is transmitted or compressed in the form of bit packet data.

FIG. 6 is a flowchart illustrating image reconstruction according to the present disclosure. In the embodiment, as shown in FIG. 6, performing the image reconstruction according to the historical frame image and the semantic feature set of the current frame image includes the following operations S601 to S602.

In S601, the feature information of each person is determined according to the ID information of the at least one person, and an image of the at least one person is generated by adopting a human image generation network according to the feature information of the at least one person.

In S602, the decompressed image is generated by adopting a full-image generation network according to the outline information of the at least one person, the image of the at least one person and the historical frame image.

The at least one person includes each person or some persons.

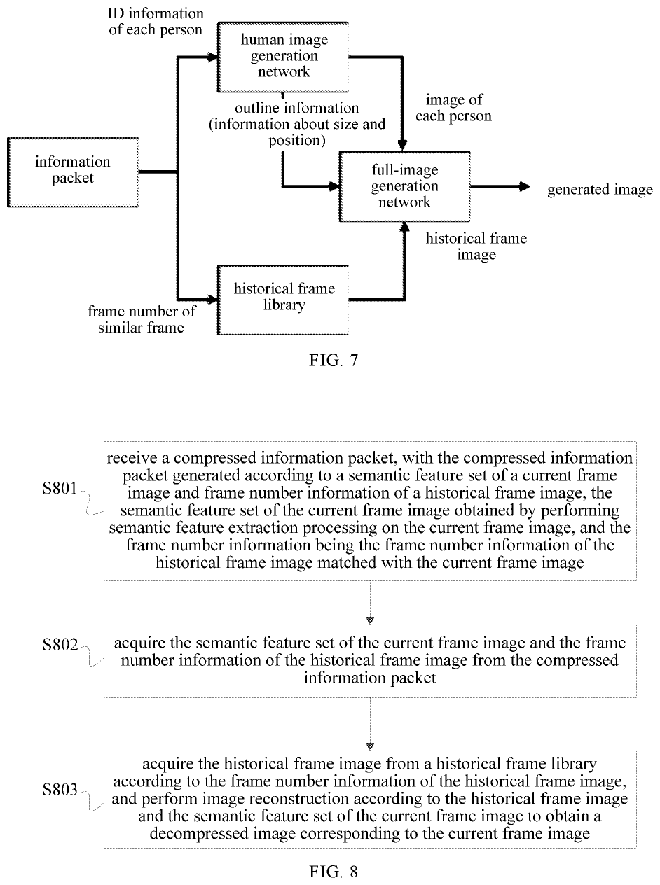

FIG. 7 is a schematic flowchart illustrating image reconstruction according to the present disclosure. In the embodiments of the present disclosure, in the process of decompressing or receiving the information packet, the image semantically similar to the original image needs to be restored based on the information in the information packet. Therefore, as shown in FIG. 7, the feature information of each person may be determined according to the ID information of each person, and then the image of each person may be generated according to the feature information of each person by adopting the human image generation network. Then the corresponding historical frame image is acquired from the historical frame library according to the number of the similar frame, and the image is generated according to the outline information, the image of each person and the historical frame image by the full-image generation network, thereby completing the decompression and/or reception of the information packet and generating the complete image. The human image generation network and the full-image generation network may be trained neural networks, for example, the neural networks may be generated and trained based on a Generative Adversarial Network (GAN).

In summary, the image processing method according to the embodiments of the present disclosure can increase the image compression ratio while ensuring the image quality, thereby allowing the image information to be transmitted and stored conveniently.

In some embodiments, a large number of background images in the practical application scenarios may also be collected to be used as a sample for the GAN, so as to be beneficial to the image reconstruction.

FIG. 8 is a flowchart illustrating yet another image processing method according to the present disclosure.

Further, as shown in FIG. 8, the present disclosure provides another image processing method, including the following operations S801 to S803.

In S801, a compressed information packet is received, with the compressed information packet generated according to a semantic feature set of a current frame image and frame number information of a historical frame image, the semantic feature set of the current frame image obtained by performing semantic feature extraction processing on the current frame image, and the frame number information being the frame number information of the historical frame image matched with the current frame image.

In the embodiment of the present disclosure, after a receiving side receives the compressed information packet, the receiving side may restore an image semantically similar to the original image based on the information in the compressed information packet and take the restored image as the current frame image. The compressed information packet is generated according to the semantic feature set of the current frame image and the frame number information of the historical frame image, a semantic feature extractor may be used to perform the semantic feature extraction processing on the current frame image to obtain the semantic feature set of the current frame image, and the frame number information may be the frame number information of the historical frame image matched with the current frame image.

In S802, the semantic feature set of the current frame image and the frame number information of the historical frame image are acquired from the compressed information packet.

In S803, the historical frame image is acquired from a historical frame library according to the frame number information of the historical frame image, and image reconstruction is performed according to the historical frame image and the semantic feature set of the current frame image to obtain a decompressed image corresponding to the current frame image.

For example, the compressed information packet may be processed to obtain the semantic feature set of the current frame image and the frame number information of the historical frame image; when the current frame image is then obtained according to the compressed information packet, the historical frame image may be first acquired from the historical frame library according to the frame number information of the historical frame image, and the image reconstruction may be performed according to the historical frame image and the semantic feature set of the current frame image. Preferably, the historical frame image may be found by searching the historical frame library based on a frame number of a similar frame (the frame number information), and then the reconstruction is performed based on the semantic feature set of the current frame to obtain the current frame image, thereby completing reception of the current frame image based on the information packet.

In the embodiment, the historical frame library may be sent to a decompression device in advance, and the decompression device stores the historical frame library after receiving the historical frame library, so that the decompression device may acquire, when receiving the compressed information packet later, the corresponding historical frame image from the historical frame library according to the frame number information of the historical frame image in the compressed information packet, and then perform the image reconstruction according to the historical frame image and the semantic feature set of the current frame image, so as to obtain the decompressed image corresponding to the current frame image. It should be noted that the decompression device may receive historical frame images again to update the historical frame library when the historical frame library needs to be updated. It should be noted that the decompression device may only receive the historical frame images which need to be updated, so as to increase an update speed of the historical frame library.

Any one of the image processing methods provided by the embodiments of the present disclosure can be applied to Virtual Reality (VR) scenarios and Mixed Reality (MR) scenarios.

It should be understood that the above embodiments may be used together with any other implementation of the embodiments of the present disclosure. The above embodiments are just specific examples of the present disclosure, and are not intended to limit the scope of the present disclosure.

Further, the present disclosure provides a computer-readable storage medium having an image processing program stored thereon. When the image processing program is executed by a processor, the image processing methods descried in the above embodiments are performed.

By allowing the processor to execute the image processing program stored on computer-readable storage medium, the computer-readable storage medium provided by the embodiment of the present disclosure can increase an image compression ratio while ensuring image quality, thereby allowing image information to be transmitted and stored conveniently.

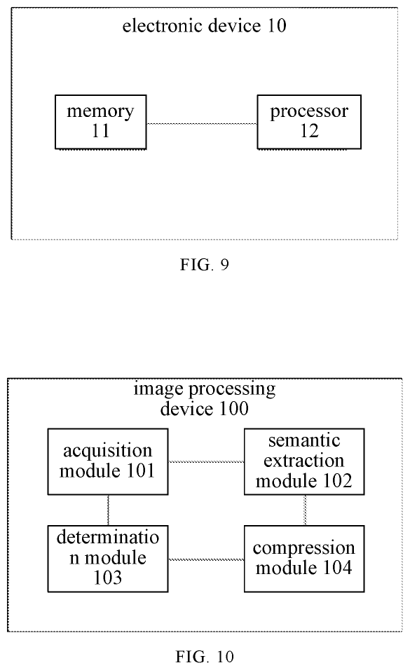

FIG. 9 is a block diagram of an electronic device according to the present disclosure.

Further, as shown in FIG. 9, the present disclosure provides an electronic device 10, including a memory 11, a processor 12, and an image processing program which is stored on the memory 11 and capable of running on the processor 12. When the processor 12 executes the image processing program, the image processing methods described in the above embodiments are performed.

The electronic device 10 provided by the embodiment of the present disclosure includes the memory 11 and the processor 12. By using the processor 12 to execute the image processing program stored on the memory 11, the electronic device 10 can increase an image compression ratio while ensuring image quality, thereby allowing image information to be transmitted and stored conveniently.

The present disclosure further provides a computer program product, including computer-readable code, or a non-volatile computer-readable storage medium carrying the computer-readable code. When the computer-readable code runs in a processor of an electronic device, the processor in the electronic device performs the above image processing methods.

FIG. 10 is a block diagram of an image processing device according to the present disclosure.

Further, as shown in FIG. 10, the present disclosure provides an image processing device 100, including an acquisition module 101, a semantic extraction module 102, a determination module 103, and a compression module 104.

The acquisition module 101 is configured to acquire a current frame image; the semantic extraction module 102 is configured to perform semantic feature extraction processing on the current frame image to obtain a semantic feature set of the current frame image; the determination module 103 is configured to determine a historical frame image matched with the current frame image and acquire frame number information of the historical frame image; and the compression module 104 is configured to generate a compressed information packet according to the semantic feature set of the current frame image and the frame number information of the historical frame image, and store and/or transmit the compressed information packet.

The acquisition module 101 is used to acquire the current frame image first, and then a semantic extractor is used by the semantic extraction module 102 to process the current frame image. Optionally, a method for processing the current frame image by the semantic extractor may include converting the image into a text description, for example, the method is performed by using Image Captioning neural network; or the method may include allocating a corresponding label and a corresponding feature value, such as color or texture, to a detected object. After the current frame image is processed, the semantic feature set of the current frame image may be obtained.

It should be noted that, in the embodiment, a history frame library is further provided and includes historical frame images, so that the determination module 103 may perform matching on the current frame image. It should be understood that the historical frame images stored in the history frame library are composed of different images, such as images of different frames in a video. After the semantic extraction module 102 acquires the semantic feature set of the current frame image and the determination module 103 determines the historical frame image matched with the current frame image and acquires the frame number information, the compression module 104 may be used to generate the compressed information packet according to the acquired information, preferably, the compression module 104 encodes the semantic feature set of the current frame image and the frame number information of the historical frame image matched with the current frame image to obtain the compressed information packet, and then stores and/or transmits the compressed information packet.

In some embodiments of the present disclosure, the image processing device further includes: a second acquisition module configured to acquire the semantic feature set of the current frame image and the frame number information of the historical frame image from the compressed information packet; and a reconstruction module configured to acquire the historical frame image from the historical frame library according to the frame number information of the historical frame image, and perform image reconstruction according to the historical frame image and the semantic feature set of the current frame image to obtain a decompressed image corresponding to the current frame image.

In some embodiments of the present disclosure, the image processing device further includes: a selection module configured to select one frame of image and store in the historical frame library at preset intervals, so as to update the historical frame library.

In some embodiments of the present disclosure, the selection module is further configured to take a frame of image whose image change satisfies a preset requirement as the historical frame image.

In some embodiments of the present disclosure, when the current frame image is an image containing a person, the semantic extraction module 102 is further configured to detect person in the current frame image, and acquire ID information of each person; recognize a person-related attribute of the current frame image to obtain feature information of each person; and encode the feature information of each person, and generate the semantic feature set of the current frame image according to an encoding result and the ID information of each person.

In some embodiments of the present disclosure, the feature information of each person includes at least one of skeleton and outline information, pose information, head angle information, hair style information and expression information of each person.

In some embodiments of the present disclosure, performing the image reconstruction according to the historical frame image and the semantic feature set of the current frame image by the reconstruction module includes: determining the feature information of each person according to the ID information of each person, and generating an image of each person by adopting a human image generation network according to the feature information of each person; and generating the decompressed image by adopting a full-image generation network according to the outline information of each person, the image of each person and the historical frame image.

It should be noted that reference may be made to the specific implementations of the image processing methods described in the above embodiments for other specific implementations of the image processing device provided by the present disclosure.

In summary, the image processing device provided by the present disclosure can increase an image compression ratio while ensuring image quality, thereby allowing image information to be transmitted and stored conveniently.

It should be understood by those of ordinary skill in the art that the functional modules/units in all or some of the steps, the systems and the devices in the methods disclosed above may be implemented as software, firmware, hardware, or suitable combinations thereof. If implemented as hardware, the division between the functional modules/units stated above is not necessarily corresponding to the division of physical components; for example, one physical component may have a plurality of functions, or one function or step may be performed through cooperation of several physical components. Some or all of the physical components may be implemented as software executed by a processor, such as a central processing unit, a digital signal processor or a microprocessor, or may be implemented as hardware, or may be implemented as an integrated circuit, such as an application specific integrated circuit. Such software may be distributed on the computer-readable storage medium.

It should be noted that the logic and/or steps illustrated in the flowcharts or described otherwise herein, such as an ordered list of executable instructions that can be considered to be configured to perform logical functions, can be embodied in any computer-readable medium, so as to be used by or used in conjunction with an instruction execution system, device or apparatus (such as a system based on a computer, a system including a processor or other systems capable of acquiring instructions from the instruction execution system, device or apparatus and executing the instructions). In the Description, a “computer-readable medium” may be any device that can contain, store, communicate, propagate or transmit programs for being used by or used in connection with the instruction execution system, device or apparatus. More specific examples (non-exhaustive list) of the computer-readable media include: an electrical connector (electronic device) having one or more wires, a portable computer cartridge (magnetic device), a Random Access Memory (RAM), a Read-Only Memory (ROM), an Erasable Programmable Read-Only Memory (EPROM or a flash memory), an optical fiber device, and a portable Compact Disk Read-Only Memory (CD-ROM). In addition, the computer-readable medium may even be paper or other suitable media on which the programs can be printed, because the program can be electronically obtained, for example, the programs can be acquired by optically scanning the paper or the other media, editing, interpreting or processing in other suitable ways if necessary, and then the programs can be stored in a memory of a computer.

It should be understood that each part of the present disclosure can be implemented as hardware, software, firmware, or a combination thereof. In the above implementations, a plurality of steps or methods may be implemented as software or firmware which is stored in a memory and executed by a suitable instruction execution system. For example, if implemented as the hardware, like in another implementation, the steps or methods may be implemented by any one of the following technologies or a combination thereof: a discrete logic circuit provided with a logic gate circuit configured to perform a logic function on data signals, an application specific integrated circuit provided with an appropriate combinational logic gate circuit, a Programmable Gate Array (PGA), and a Field Programmable Gate Array (FPGA).

The computer program product described herein may be embodied as hardware, software, or a combination thereof. The computer program product is embodied as a computer storage medium in one alternative embodiment, and is embodied as a software product such as the Software Development Kit (SDK) in another alternative embodiment.

Each aspect of the present disclosure is described herein with reference to the flowcharts and/or block diagrams of the method, the device (system) and the computer program product provided by the embodiments of the present disclosure. It should be understood that each block in the flowcharts and/or block diagrams and combinations of the blocks in the flowcharts and/or block diagrams may be implemented by computer-readable program instructions.

Those computer-readable program instructions may be provided for a processor of a general-purpose computer, a special-purpose computer or other programmable data processing devices to produce a machine, so that the instructions create, when executed by the processor of the computer or the other programmable data processing devices, a device which performs the functions/actions specified in one or more blocks in the flowcharts and/or block diagrams. Those computer-readable program instructions may also be stored in the computer-readable storage medium and enable the computer, the programmable data processing device and/or other apparatus to function in a particular manner, so that the computer-readable medium storing the instructions includes a manufactured product, which includes the instructions for implementing each aspect of the functions/actions specified in one or more blocks in the flowcharts and/or block diagrams.

The computer-readable program instructions may also be loaded in the computer, the other programmable data processing devices or the other devices to allow a series of operational steps to be performed on the computer, the other programmable data processing devices or the other devices to produce a computer-implemented process, so that the instructions which are executed on the computer, the other programmable data processing devices or the other devices perform the functions/actions specified in one or more blocks in the flowcharts and/or block diagrams.

The flowcharts and the block diagrams in the drawings illustrate the architecture, functions and operations that may be implemented by the systems, methods and computer program products according to the plurality of embodiments of the present disclosure. Each block in the flowcharts or block diagrams can represent a module, a program segment, or a part of an instruction, and the module, the program segment or the part of the instruction includes one or more executable instructions configured to perform specified logical functions. In some alternative implementations, the functions illustrated by the blocks may occur in an order different from that illustrated in the drawings. For example, two consecutive blocks may in fact be substantially executed in parallel, or may sometimes be executed in a reverse order, and the order in which the two blocks are executed depends on the functions involved. It should be further noted that each block in the block diagrams and/or flowcharts and the combinations of the blocks in the block diagrams and/or flowcharts may be implemented by a hardware-based dedicated system which performs the specified functions or actions, or by a combination of dedicated hardware and computer instructions.

In the Description, the reference term such as “an embodiment”, “some embodiments”, “an example”, “a specific example” or “some examples” means that the specific features, structures, materials or characteristics described in connection with the embodiment(s) or example(s) are included in at least one embodiment or example of the present disclosure. In the Description, the illustrative description of the above terms does not necessarily refer to the same embodiment or example. Further, the specific features, structures, materials or characteristics described may be combined in a suitable way in any one or more of the embodiments or examples.

In the description of the present disclosure, it should be understood that the orientations and positional relationships indicated by the terms “central”, “longitudinal”, “lateral”, “length”, “width”, “thickness”, “on”, “under”, “front”, “back”, “left”, “right”, “vertical”, “horizontal”, “top”, “bottom”, “inside”, “outside”, “clockwise”, “counterclockwise”, “axial”, “radial” and “circumferential” are the orientations and positional relationships based on the drawings, the terms are used just for the convenience of describing the present disclosure and simplifying the description, rather than indicating or implying that the device or element described must have a particular orientation or be constructed and operated in a particular orientation. Therefore, those terms should not be interpreted as limitation to the present disclosure.

Further, the terms “first”, “second” and the like used in the embodiments of the present disclosure are just for the purpose of description, and should not to be interpreted as indicating or implying relative importance or implicitly indicating the number of the technical features described in the embodiments. Thus, the features modified by the terms such as “first” and “second” in an embodiment of the present disclosure may explicitly or implicitly indicate that the embodiment includes at least one of the features. In the description of the present disclosure, the term “a plurality of” means at least two or more than two, such as two, three or four, unless expressly defined otherwise in the embodiments.

In the present disclosure, unless expressly specified or defined otherwise in the embodiments, the terms “mount”, “couple”, “connect” and “fix” in the embodiments shall be interpreted according to their broad meanings, for example, “connect” may refer to fixed connection, or detachable connection, or connected into an integral body, and it should be understood that “connect” may also refer to mechanical connection or electrical connection; apparently, “connect” may also refer to direct connection, or indirect connection through an intermediate medium, or communication between interiors of two elements, or an interaction relationship between the two elements. Those of ordinary skill in the art can understand the specific meanings of the above terms in the present disclosure according to the specific implementations.

In the present disclosure, unless expressly specified or defined otherwise, a first feature being “on” or “under” a second feature may refer to direct contact between the first feature and the second feature or indirect contact between the first feature and the second feature through an intermediate medium. Moreover, the first feature being “on” or “above” or “over” the second feature may refer to that the first feature is right above the second feature or is obliquely over the second feature, or just refer to that the first feature is higher than the second feature in terms of horizontal height. The first feature being “under” or “below” or “beneath” the second feature may refer to that the first feature is right under the second feature or is obliquely below the second feature, or just refer to that the first feature is lower than the second feature in terms of horizontal height.

Although the embodiments of the present disclosure are illustrated and described above, it should be understood that the above embodiments are exemplary and should not to be interpreted as limitation to the present disclosure, and those of ordinary skill in the art can make changes, modifications, substitutions and variations to the above embodiments within the scope of the present disclosure.

1. An image processing method, comprising:
acquiring a current frame image, and performing semantic feature extraction processing on the current frame image to obtain a semantic feature set of the current frame image;
determining a historical frame image matched with the current frame image, and acquiring frame number information of the historical frame image; and
generating a compressed information packet according to the semantic feature set of the current frame image and the frame number information of the historical frame image, and storing and/or transmitting the compressed information packet.

2. The image processing method of claim 1, after storing the compressed information packet, further comprising:
acquiring the semantic feature set of the current frame image and the frame number information of the historical frame image from the compressed information packet; and
acquiring the historical frame image from a historical frame library according to the frame number information of the historical frame image, and performing image reconstruction according to the historical frame image and the semantic feature set of the current frame image to obtain a decompressed image corresponding to the current frame image.

3. The image processing method of claim 2, wherein one frame of image is selected and stored in the historical frame library at preset intervals, so as to update the historical frame library.

4. The image processing method of claim 3, wherein a frame of image whose image change satisfies a preset requirement is taken as the historical frame image.

5. The image processing method of claim 2, wherein in a case where the current frame image is an image containing a person, performing the semantic feature extraction processing on the current frame image comprises:
detecting person in the current frame image, and acquiring Identity Document (ID) information of at least one person;
recognizing a person-related attribute of the current frame image to obtain feature information of the at least one person; and
encoding the feature information of the at least one person, and generating the semantic feature set of the current frame image according to an encoding result and the ID information of the at least one person.

6. The image processing method of claim 5, wherein the feature information of the person comprises at least one of skeleton and outline information, pose information, head angle information, hair style information, and expression information of the person.

7. The image processing method of claim 6, wherein performing the image reconstruction according to the historical frame image and the semantic feature set of the current frame image comprises:
determining the feature information of the at least one person according to the ID information of the at least one person, and generating, according to the feature information of the at least one person, an image of the at least one person by adopting a human image generation network; and
generating the decompressed image by adopting a full-image generation network according to the outline information of the at least one person, the image of the at least one person and the historical frame image.

8. An image processing method, comprising:
receiving a compressed information packet, wherein the compressed information packet is generated according to a semantic feature set of a current frame image and frame number information of a historical frame image, the semantic feature set of the current frame image is obtained by performing semantic feature extraction processing on the current frame image, and the frame number information is the frame number information of the historical frame image matched with the current frame image;
acquiring the semantic feature set of the current frame image and the frame number information of the historical frame image from the compressed information packet; and
acquiring the historical frame image from a historical frame library according to the frame number information of the historical frame image, and performing image reconstruction according to the historical frame image and the semantic feature set of the current frame image to obtain a decompressed image corresponding to the current frame image.

9. A non-transitory computer-readable storage medium having stored thereon an image processing program, which, when executed by a processor, causes the processor to perform the image processing method of claim 1.

10. An electronic device, comprising a memory, a processor, and an image processing program which is stored on the memory and capable of running on the processor, wherein when the processor executes the image processing program, the image processing method of claim 1 is performed.

11. An image processing device, comprising:
an acquisition module configured to acquire a current frame image;
a semantic extraction module configured to perform semantic feature extraction processing on the current frame image to obtain a semantic feature set of the current frame image;
a determination module configured to determine a historical frame image matched with the current frame image and acquire frame number information of the historical frame image; and
a compression module configured to generate a compressed information packet according to the semantic feature set of the current frame image and the frame number information of the historical frame image, and store and/or transmit the compressed information packet.

12. The image processing method of claim 3, wherein in a case where the current frame image is an image containing a person, performing the semantic feature extraction processing on the current frame image comprises:
detecting person in the current frame image, and acquiring ID information of at least one person;
recognizing a person-related attribute of the current frame image to obtain feature information of the at least one person; and
encoding the feature information of the at least one person, and generating the semantic feature set of the current frame image according to an encoding result and the ID information of the at least one person.

13. The image processing method of claim 12, wherein the feature information of the person comprises at least one of skeleton and outline information, pose information, head angle information, hair style information, and expression information of the person.

14. The image processing method of claim 13, wherein performing the image reconstruction according to the historical frame image and the semantic feature set of the current frame image comprises:
determining the feature information of the at least one person according to the ID information of the at least one person, and generating, according to the feature information of the at least one person, an image of the at least one person by adopting a human image generation network; and
generating the decompressed image by adopting a full-image generation network according to the outline information of the at least one person, the image of the at least one person and the historical frame image.

15. The image processing method of claim 4, wherein in a case where the current frame image is an image containing a person, performing the semantic feature extraction processing on the current frame image comprises:
detecting person in the current frame image, and acquiring ID information of at least one person;
recognizing a person-related attribute of the current frame image to obtain feature information of the at least one person; and
encoding the feature information of the at least one person, and generating the semantic feature set of the current frame image according to an encoding result and the ID information of the at least one person.

16. The image processing method of claim 15, wherein the feature information of the person comprises at least one of skeleton and outline information, pose information, head angle information, hair style information, and expression information of the person.

17. The image processing method of claim 16, wherein performing the image reconstruction according to the historical frame image and the semantic feature set of the current frame image comprises:
determining the feature information of the at least one person according to the ID information of the at least one person, and generating, according to the feature information of the at least one person, an image of the at least one person by adopting a human image generation network; and
generating the decompressed image by adopting a full-image generation network according to the outline information of the at least one person, the image of the at least one person and the historical frame image.

18. A non-transitory computer-readable storage medium having stored thereon an image processing program, which, when executed by a processor, causes the processor to perform the image processing method of claim 8.

19. An electronic device, comprising a memory, a processor, and an image processing program which is stored on the memory and capable of running on the processor, wherein when the processor executes the image processing program, the image processing method of claim 8 is performed.
